(19) United States
(12) Patent Application Publication
(10) Pub. No.: US 2005/0074647 A1
(43) Pub. Date: Apr. 7, 2005

(54) Variably insulated system and method of use

(76) Inventor: Alan R. Arthur, Salem, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/678,427

(22) Filed: Oct. 2, 2003

(51) Int. Cl. H01M 8/04; H01M 8/12

(52) U.S. Cl. 429/26; 429/30

(57) ABSTRACT

A variably insulated system includes a heat generating core, a heat sink, and a heat responsive coupling member configured to selectively couple the heat generating core and the heat sink at predetermined temperatures of the heat generating core.

### BACKGROUND

During the past several years, the popularity and viability of fuel cells for producing both large and small amounts of electricity has increased significantly. Fuel cells conduct an electrochemical reaction with reactants such as hydrogen and oxygen to produce electricity and heat.

Fuel cells provide a DC (direct current) voltage that may be used to power motors, lights, computers, or any number of electrical appliances. A typical fuel cell includes an electrolyte disposed between an anode and a cathode. There are several different types of fuel cells, each having a different chemistry. Fuel cells are usually classified by the type of electrolyte used and are generally categorized into one of five groups: proton exchange membrane (PEM) fuel cells, alkaline fuel cells (AFC), phosphoric-acid fuel cells (PAFC), solid oxide fuel cells (SOFC), and molten carbonate fuel cells (MCFC).

While all fuel cells have some desirable features, solid oxide fuel cells (SOFC) have a number of distinct advantages over other fuel cell types. Some advantages of SOFCs include reduced problems with electrolyte management, high efficiencies (SOFCs are up to 60% efficient), high tolerance to fuel impurities, and the potential for internal reforming of hydrocarbon fuels to produce hydrogen and methane.

SOFC systems typically include a number of stacks of fuel cells formed on ceramic substrates. SOFC systems are heat generating systems that do not begin generating electricity until they reach their operating temperatures (500-900° C.). Accordingly, many systems attempt to quickly raise the temperature of the fuel cell stacks during their initial start up sequence. Rapid elevation of the system to its operating temperature is often achieved by reducing the flow geometry of the SOFC as well as limiting the heat loss by insulating the fuel cell stacks within an insulated “box.” Once the fuel cell stacks reach their operating temperature, the electrochemical reaction continues to heat the fuel cell stack beyond its operating temperature. This continued heating of the fuel cell stack, if not controlled, may cause thermal runaway. In order to provide the required cooling for the cell, current systems force up to 800% of the air that is stoichiometrically required for the SOFC reaction through the fuel cell stack. This high air flow affects the pressure balance of the system by reducing the system pressure. Additionally, the high air flow requires large and expensive air movers. The larger the air movers used by the system, the more power consumption and less net power available from the overall fuel cell system. Additionally, the effectiveness of the forced air flow is reduced by the insulation provided to aid in the rapid elevation of system temperature during startup. Consequently, during fuel cell start up thermal resistance is preferably maximized while during steady state operation thermal resistance is preferably reduced.

### SUMMARY

A variably insulated system includes a heat generating core, a heat sink, and a heat responsive coupling member configured to selectively-couple the heat generating core and the heat sink at predetermined temperatures of the heat generating core.

### BRIEF DESCRIPTION OF THE DRAWINGS

The accompanying drawings illustrate various embodiments of the present disclosure and are a part of the specification.

FIG. 1A illustrates a cross sectional view of a variably insulated system according to one exemplary embodiment.

FIG. 1B illustrates a cross sectional view of a variably insulated system according to one exemplary embodiment.

FIG. 2 illustrates a perspective view of a variably insulated system according to one exemplary embodiment.

FIG. 3 is a flowchart of a method of regulating heat in a heat generating system according to one exemplary embodiment.

The illustrated embodiments are merely examples of the present system and method and do not limit the scope of the disclosure. Throughout the drawings, identical reference numbers designate similar, but not necessarily identical, elements.

### DETAILED DESCRIPTION

A variably insulated system includes a heat generating core, a heat sink, and a heat responsive coupling member configured to selectively couple the heat generating core and the heat sink at predetermined temperatures of the heat generating core. Further, the present variably insulated system is a system that is rapidly heated to its operating temperature by maintaining a high level of thermal resistance between the heat sink and the heat generating core during initial startup. Once the system has reached its operating temperature, excess heat is efficiently removed by lowering the thermal resistance between the heat generating core and the heat sink.

As used herein and in the appended claims, a shape memory alloy shall be broadly understood to mean any material that yields a thermoelastic martensite that undergoes a martensitic transformation of a type that allows the alloy to be deformed by a twinning mechanism below the transformation temperature. The deformation is then reversed when the twinned structure reverts upon heating to the parent phase.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Structure

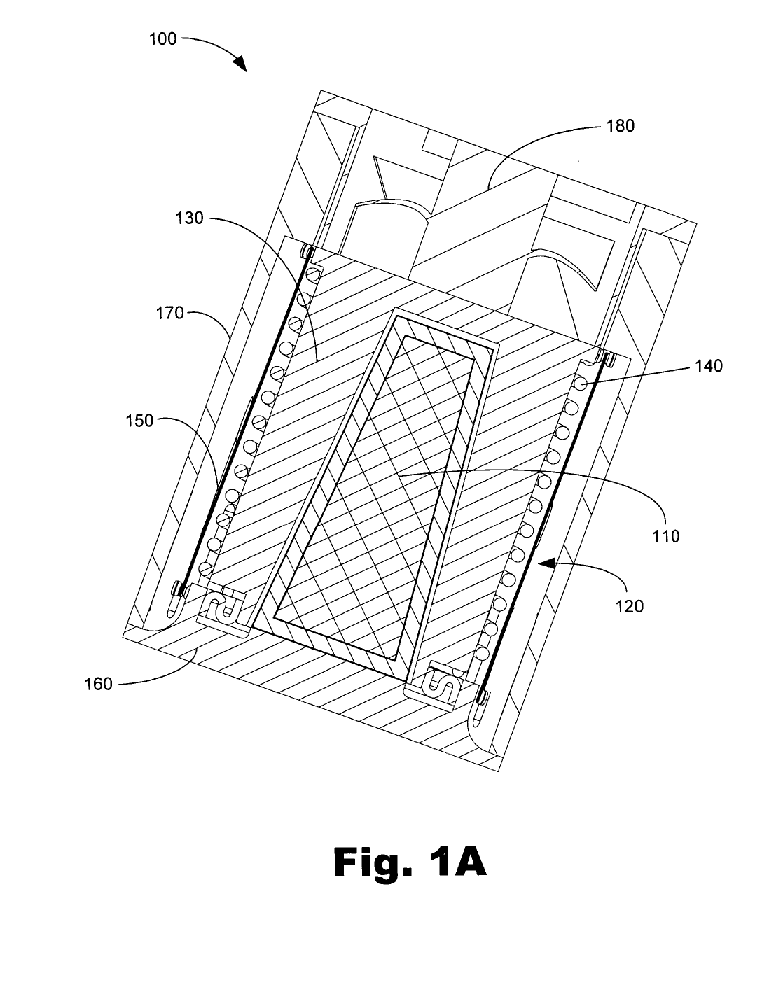

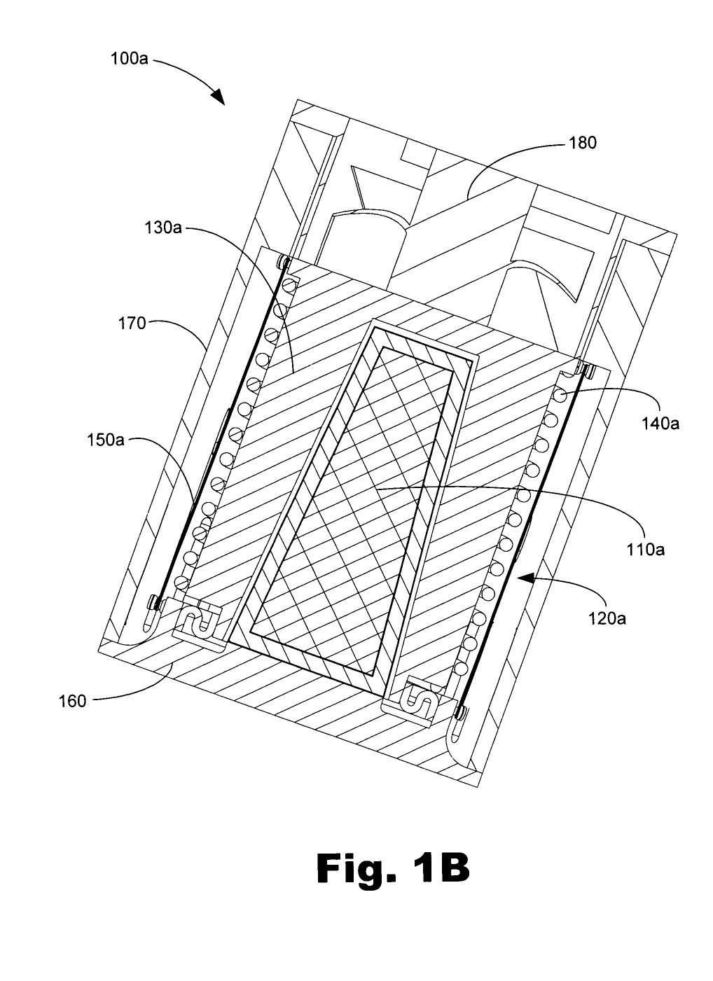

FIG. 1A illustrates a cross-sectional view of a variably insulated system (100) according to one exemplary embodiment. As shown in FIG. 1A, the present variably insulated system (100) generally includes a heat generating core (110), a heat responsive coupling member (120), a base (160), a fan assembly (180), a shell (170), and a heat sink (130).

The heat generating core (110) illustrated in FIG. 1 may be any heat generating device that functions with increased performance depending on the point of operation of the heat generating device. For ease of explanation only, the present heat generating device (110) will be described in the context of an SOFC fuel cell stack.

As shown in FIG. 1A, a heat sink (130) may be selectively coupled to the heat generating core (110) by the heat responsive coupling member (120). The heat sink illustrated in FIG. 1 may be any thermally conductive material shaped so as to maximize surface area and consequently heat dissipation including, but in no way limited to a metal such as copper or aluminum.

The heat responsive coupling member (120) illustrated in FIG. 1A includes a shape memory alloy (150) and a spring member (140). As shown in FIG. 1A, both the shape memory alloy (150) and the spring member (140) may be coupled to the heat sink (130) and the base (160) according to one exemplary embodiment. The shape memory alloy (150) illustrated in FIG. 1A may be any alloy that yields a thermoelastic martensite that may be deformed by a twinning mechanism below the transformation temperature. The deformation is then reversed when the twinned structure reverts upon heating to the parent phase. Additionally, the spring member (140) may be any member configured to provide a resistive separating force between the heat sink (130) and the heat generating core including, but in no way limited to, a coil spring, or a flexible member. The heat responsive coupling member (120) couples the heat generating core (110) and the heat sink (130) at predetermined temperatures of the heat generating core (110).

A fan assembly (180) is also illustrated in FIG. 1A as forming part of the variably insulated system (100). The fan assembly (180) may be any device capable of providing a specified quantity of air to the present system.

The variably insulated system (100) illustrated in FIG. 1A is shown at ambient temperature. Resistive separating force from the spring member (140) prevents physical contact between the heat sink (130) and the heat generating core (110) despite the presence of the shape memory alloy (150). Accordingly, the heat sink (130) is physically separated from the heat generating core (110) by the heat responsive coupling member (120) at ambient temperature. Further, the heat generating system (100) is supported by a base (160) and a shell (170) also extends between the base (160) and a fan assembly (180).

Exemplary Implementation and Operation

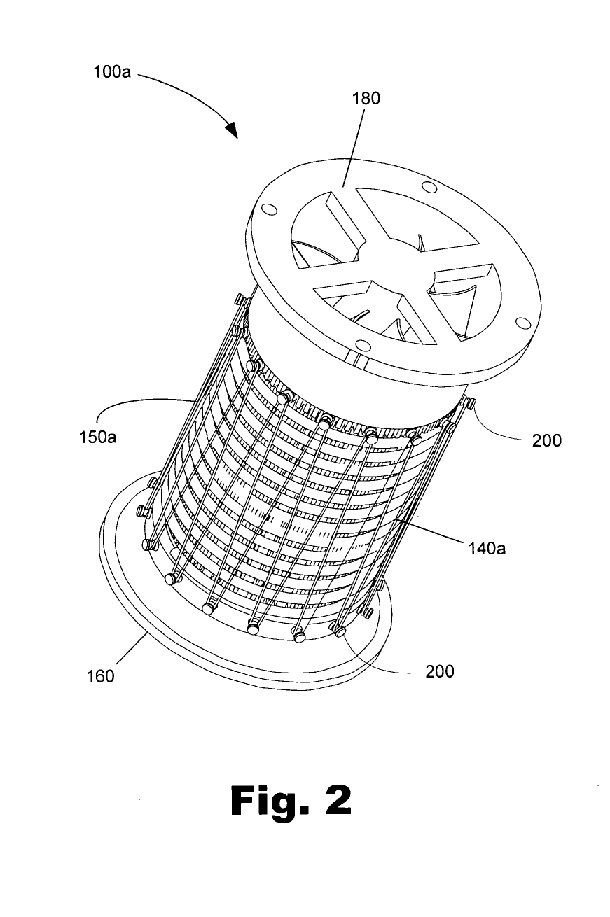

FIG. 1B illustrates a variably insulated system (100a) wherein the heat generating core (110; FIG. 1) is a fuel cell stack (110a), such as an SOFC stack, functioning at its operating temperature. During operation, the variably insulated system (100a) shown in FIG. 2 is a dynamic system in which contact between the heat sink (130a) and the fuel cell stack (110a) varies as the fuel cell stack is cycled between ambient temperature and operating temperature. Similar to the system described with reference to FIG. 1, the heat sink (130a) is physically separated from the fuel cell stack (110a) by a compressive spring (140a) at ambient temperature despite the presence of the shape memory alloy (150a). With the heat sink (130a) being physically separated from the fuel cell stack (110; FIG. 1), rapid heating of the fuel cell stack (110a) may be achieved during startup due to the relatively high thermal resistance between the fuel cell stack (110a) and the heat sink (130a). The resistance may be further enhanced by evacuating air from the gap between the heat sink (130a) and the fuel cell stack (110a).

The initial heating may be achieved by convectively heating air entering the fuel cell stack (110a) with a heat exchanger (not shown). As the heated air enters the fuel cell stack (110a), the assembly may quickly reach the operating temperature of the fuel cell stack (110a). The heat produced by the heated air and the operation of the fuel cell stack (110a) raises the temperature of both the fuel cell stack (110a) and the coupling assembly (120a). As the shape memory alloy (150a) is heated to its transition temperature, it begins to contract. Once the contraction of the shape memory alloy (150a) is sufficient to overcome the resistive force of the compression spring (140a), the heat sink (130a) and the fuel cell stack (110a) are drawn into contact with each other by the shape memory alloy (150a).

Accordingly, the heat sink (130a) is placed in contact with the fuel cell stack (110a) in response to a rise in temperature. The raise in temperature may be attributed to heat generated by the fuel cell stack and/or the heated air. The contact between the fuel cell and the heat sink (130a) lowers the thermal resistance between the fuel cell stack and the heat sink, thereby facilitating the flow of heat from the fuel cell stack to the heat sink. This contact occurs after the fuel cell stack (110a) is hotter than the transitional temperature of the shape memory alloy (150a). Accordingly, the shape memory alloy (150a) may be configured such that its transitional temperature is near the operating temperature of the fuel cell stack.

In the exemplary implementation illustrated in FIG. 2, the shape memory alloy (150a) is strung in an alternating fashion over posts (200) coupled both to the heat sink (130a; FIG. 1B) and the base (160). Similarly, FIG. 2 shows the compressive spring (140a) coiled around the heat sink (130a; FIG. 1B) to tension the shape memory alloy (150a). While the fuel cell is functionally operating, excess heat is removed by directed air from the fan assembly (180) over the heat sink (130a; FIG. 1B).

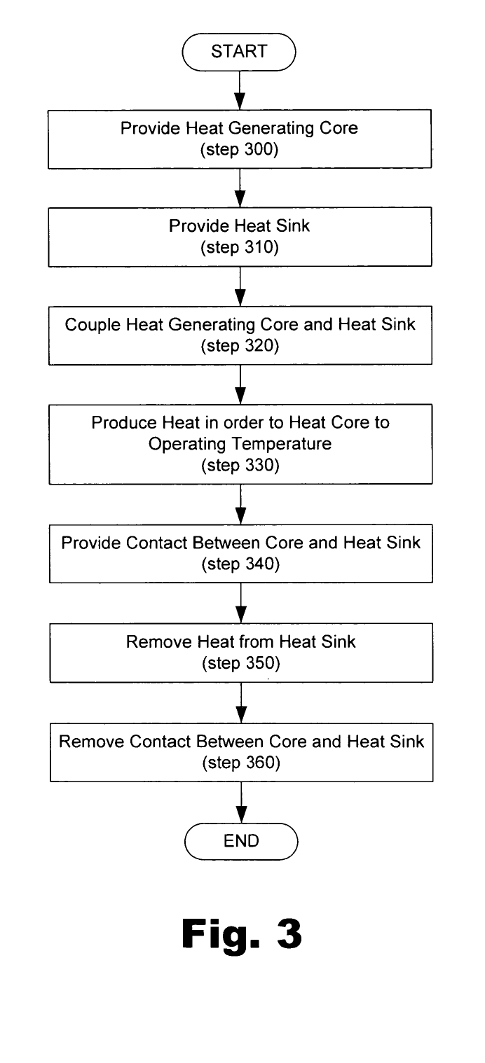

FIG. 3 is a flowchart illustrating a method of regulating the heat transfer of a heat generating core such as a fuel cell stack according to one exemplary embodiment. As shown in FIG. 3, the process begins by providing a heat generating core (step 300). The heat generating core may be any core that generates heat including, but in no way limited to, fuel cell cores such as SOFC fuel cell cores. Further, the heat generating core may be a heat generating core that operates more efficiently at an elevated operating temperature.

The present method further includes providing a heat sink (step 310). Examples of possible heat sinks include, but are in no way limited to, metallic heat sinks such as copper or aluminum heat sinks. Once both the heat sink and the heat generating core are provided, the heat sink and the heat generating core are coupled by a heat responsive coupling member (step 320). As stated above, one exemplary embodiment of the heat responsive coupling member (120; FIG. 1) may include a shape memory alloy (150; FIG. 2) and a spring member (140; FIG. 2). The heat responsive coupling member is configured to selectively place the heat sink in contact with the heat generating core in response to predetermined changes in temperature.

With the heat sink coupled to the heat generating core, the heat generating core is operated to produce heat (step 330). Additionally, as stated previously, heated air may be provided to facilitate the initial heating of the heat generating core. While the heat generating core produces heat to heat core to its operating temperature (step 330), the heat sink is not in physical or thermal contact with the heat generating core. Accordingly, a relatively high thermal resistance exists between the heat sink and the heat generating core. This high thermal resistance aids in the start up of the heat generating core by reducing the time necessary for the heat generating core to reach its operating temperature.

As the heat generating core approaches or exceeds its operating temperature, the thermally responsive coupling member (120; FIG. 1) places the heat sink and the heat generating core in physical contact, thereby reducing the thermal resistance between the heat generating core and the heat sink (step 340). This contact occurs as a result of changes in the shape memory alloy (150; FIG. 2) at a predetermined level.

During the initial heating of the heat generating core (step 330), thermal energy is also transferred to the heat sink and the coupling assembly (120; FIG. 1). Consequently, as the heat generating core is heated, the heat sink and the shape memory alloy also rise in temperature.

Once the transition temperature of the shape memory alloy (150; FIG. 2) is reached, the shape memory alloy will contract and overcome the resistive force of the spring member (140; FIG. 1) thereby causing the heat sink to be physically coupled to the heat producing core. This physical coupling also causes the heat sink and the heat generating core to be thermally coupled.

When coupled, the heat sink facilitates the dissipation of thermal energy from the heat generating core thereby lowering the thermal resistance of the system during the functional operation of the heat generating core. As a result, heat is readily transferred from the heat generating core to the heat sink preventing thermal runaway. Accordingly, the heat sink is then cooled (step 350), thereby indirectly cooling the heat generating core. This cooling may be accomplished by flowing an air stream or fluid over the heat sink. The lower thermal resistance accomplished by the coupling of the heat sink to the heat generating core facilitates the removal of larger quantities of heat from the heat generating core.

By appropriately designing the heat sink, the heat sink contact area, and the shape memory alloy transition temperature, the present system and method provide for fast heat up of a heat generating system during its initial heating process while simultaneously providing a manner for efficient cooling of the system thereafter. Cooling of the heat sink and consequently the heat generating core (step 350) involves managing heat flux from the system by varying air flow over the heat sink with the fan assembly. This variation of air flow allows for changing the average free stream temperature seen by the heat sink rather than the amount of cathode air introduced to the heat generating cores of the system.

Once the heat generating core has ceased operation, the heat generating core no longer produces heat and the core cools to ambient temperature. As the system cools, the coupling assembly (120; FIG. 1) also cools. As the shape memory alloy (150; FIG. 1) cools below its transition temperature, the shape memory alloy (150; FIG. 2) yields to the force of the spring causing the heat sink to once again be removed from physical contact with the heat generating core (step 360).

As described, the present system and method provide for selective switching between non-contact and contact of a heat sink with respect to a heat producing core in response to the temperature of the heat generating core. This switching is accomplished through the use of a spring element and shape memory alloy. When the variably insulated system cools below the transition temperature, the shape memory alloy is relatively weak and yields under the force of the spring. This results in loss of contact between the heat sink and the heat producing core (step 360). This resulting loss of contact greatly increases the thermal resistance between the heat sink and the heat producing core, facilitating fast heat up.

Further, once a transition temperature is met in the shape memory alloy, the spring force is overcome causing the heat sink to come into contact with the head generating core. The heat in the heat generating core may then be transferred to the heat sink and removed by a cooling air stream. By selectively placing the heat sink into contact with the heat producing core, the present configuration reduces the amount of excess cathode air required to cool the system. This reduction of cathode air lowers the pressure drop of the system, which leads to higher system efficiencies. Accordingly, the present method provides for a system that quickly reaches its operating temperature while efficiently removing excess heat with a minimum flow of excess cathode air.

In the case of an SOFC, heat is produced initially by combusting fuel in order to bring the system up to its operating temperature. Once the fuel cell system is at its operating temperature, it begins to produce power and heat through an electrochemical reaction. The system may be designed such that the contraction of the shape memory alloy places the heat sink in contact with the SOFC at a temperature corresponding with the operating temperature of the SOFC. Accordingly, the present system then removes excess heat generated by the electrochemical reaction through the heat sink due to the decreased thermal resistance between the SOFC and the heat sink. As explained above, the operation and specifics of the electrochemical reaction conducted in and the electrolyte and electrode structure of SOFCs are well known in the art.

### ALTERNATIVE EMBODIMENTS

In an alternative embodiment (not shown), a heat generating system has a heat responsive coupling member that includes a bimetallic member. Production of heat by the heat generating core (110; FIG. 1) is transferred somewhat to the bimetallic member. This heat causes a differential expansion of the bimetallic member. The bimetallic member is configured such that the differential expansion urges the heat sink (130; FIG. 1) into contact with the heat generating core (110; FIG. 1) at a specified temperature, thereby reducing the thermal resistance between the two as discussed above. As a result, the use of a bimetallic member may facilitate the rapid heating of a heat generating core to its operating temperature by automatically controlling the thermal resistance between a heat generating core and a heat sink. Moreover, when the heat generating core and the bimetallic member are cooled, the heat sink is removed from the heat generating core eliminating the low thermal resistance. Essentially, the thermal resistance of the system may be controlled by selective physical contact between the heat sink and the heat generating core. In systems utilizing a bimetallic member, the bimetallic member would act as a heat responsive coupling member (120; FIG. 1A, 120a; FIG. 1B) thereby replacing the shape memory alloy (150; FIG. 1A, 150a; FIG. 1B) and the spring member (140; FIG. 1A) or a compressive spring (140a; FIG. 1B).

In other embodiments not shown, physical contact between the heat sink and the heat generating core may be controlled by machine actuated cores that selectively place the heat sink in contact with the heat generating core at specified temperatures. Accordingly, any mechanism or structure may be employed that controls the thermal resistance between a heat removal system, such as a heat sink, and a heat generating core. Further, any structure may be employed that controls physical contact between a heat removal system, such as a heat sink, and a heat generating core including, but in no way limited to, a machine actuated member such as a solenoid and a sensor. As a result, a solenoid and a sensor may be used as a heat responsive coupling member as in FIGS. 1A and 1B.

In conclusion, the present system and method vary the thermal resistance of insulation used to contain a heat generating core. More specifically, the present system and method provide for selectively placing a heat sink in contact with an SOFC stack depending on the temperature of the SOFC stack. This system and method reduces thermal losses during the SOFC start up phase while facilitating heat transfer during steady state operation of the SOFC thereby preventing thermal runaway.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the present system and method be defined by the following claims.

1. A variably insulated system, comprising:
a heat generating core;
a heat sink; and
a heat responsive coupling member configured to selectively couple said heat generating core and said heat sink at predetermined temperatures of said heat generating core.

2. The system of claim 1, wherein said predetermined temperature comprises an operating temperature of said heat generating core.

3. The system of claim 1, wherein said heat responsive coupling member comprises a shape memory alloy.

4. The system of claim 3, wherein said heat responsive coupling member further comprises a spring coupled to said shape memory alloy.

5. The system of claim 1, wherein said coupling member comprises a bimetallic strip.

6. The system of claim 1, wherein said coupling member comprises a machine actuated member and a sensor.

7. The system of claim 1, wherein said heat generating core comprises a fuel cell system.

8. The system of claim 7, wherein said heat generating core comprises a solid oxide fuel cell.

9. The system of claim 1, wherein said heat sink comprises a metallic material.

10. The system of claim 9, wherein said metallic material comprises one of copper or aluminum.

11. An electrochemical system, comprising:
an electrochemical core;
a heat sink; and
a heat responsive coupling member configured to selectively couple said electrochemical core and said heat sink at predetermined temperatures of said electrochemical core.

12. The system of claim 11, wherein said predetermined temperature comprises an operating temperature of said electrochemical core.

13. The system of claim 11 wherein said heat responsive coupling member comprises a shape memory alloy.

14. The system of claim 13, wherein said heat responsive coupling member further comprises a spring coupled to said shape memory alloy.

15. The system of claim 11, wherein said coupling member comprises a bimetallic strip.

16. The system of claim 11, wherein said coupling member comprises a machine actuated member and a sensor.

17. The system of claim 11 wherein said electrochemical core comprises a fuel cell system.

18. The system of claim 17, wherein said electrochemical core comprises a solid oxide fuel cell system.

19. The system of claim 11, wherein said heat sink comprises a metallic material.

20. The system of claim 19, wherein said metallic material comprises one of copper or aluminum.

21. A solid oxide fuel cell housing comprising:
a solid oxide fuel cell;
a heat sink; and
a heat responsive coupling member configured to selectively couple said solid oxide fuel cell and said heat sink at predetermined temperatures of said solid oxide fuel cell.

22. The solid oxide fuel cell housing of claim 21, wherein said predetermined temperature of said solid oxide fuel cell comprises an operating temperature of said solid oxide fuel cell.

23. The solid oxide fuel cell housing of claim 21, wherein said heat responsive coupling member comprises a shape memory alloy coupled to a spring.

24. The solid oxide fuel cell housing of claim 21, wherein said heat responsive coupling member comprises a bimetallic strip.

25. The solid oxide fuel cell housing of claim 21, wherein said heat responsive coupling member comprises a machine actuated member and a sensor.

26. The solid oxide fuel cell housing of claim 21, wherein said heat sink comprises a metallic material.

27. The solid oxide fuel cell housing of claim 26, wherein said metallic material comprises one of copper or aluminum.

28. A method of using a variably insulated system, comprising:
providing a heat generating core;
applying thermal energy to said core; and
placing a heat sink in thermal contact with said heat generating core at a pre-determined temperature in response to said application of thermal energy.

29. The method of claim 28, further comprising cooling said heat sink.

30. The method of claim 28, wherein said cooling comprises introducing air flow around said heat sink.

31. The method of claim 28, further comprising removing said heat sink from thermal contact with said heat generating system in response to a decrease in said thermal energy.

32. The method of claim 28, wherein said placing a heat sink in thermal contact with said heat generating core further comprises implementing a heat responsive coupling member.

33. The method of claim 32, wherein said heat responsive coupling member comprises a shape memory alloy coupled to a spring.

34. The method of claim 32, wherein said coupling member comprises a bimetallic strip.

35. The method of claim 32, wherein said coupling member comprises a machine actuated member and a sensor.

36. The system of claim 28, wherein said heat generating core comprises a fuel cell assembly.

37. The system of claim 28, wherein said heat generating core comprises a solid oxide fuel cell.

38. The system of claim 28, wherein said applying thermal energy comprises using a heat exchanger.

39. The system of claim 28, wherein said heat sink comprises a metallic material.

40. The system of claim 39, wherein said metallic material comprises one of copper or aluminum.

41. A variably insulated system, comprising:
a heat generating core;
a means for dissipating heat from said heat generating core; and
a means for coupling for selectively coupling said means for dissipating heat to said heat generating core at predetermined temperatures of said heat generating core.

42. The variably insulated system of claim 41, further comprising means for cooling said means for dissipating heat.

43. The variably insulated system of claim 42, wherein said means for cooling comprise a fan.

44. The variably insulated system of claim 41, wherein said heat generating core comprises a solid oxide fuel cell.

45. The variably insulated system of claim 41, wherein said means for dissipating heat comprise a heat sink.

46. The variably insulated system of claim 45, wherein said heat sink comprises one of copper or aluminum.

47. The variably insulated system of claim 41, wherein said means for coupling comprise a spring coupled to a shape memory alloy.

48. The variably insulated system of claim 41, wherein said means for coupling comprise a bimetallic strip.

49. The variably insulated system of claim 41, wherein said means for coupling comprise a machine actuated member and a sensor.
